(19) United States
(12) Patent Application Publication
(10) Pub. No.: US 2011/0201329 A1
(43) Pub. Date: Aug. 18, 2011

(54) COMMUNICATIONS MANAGEMENT

(76) Inventor: Phillip Carter, Berkshire (GB)

(21) Appl. No.: 12/737,001

(22) PCT Filed: Jun. 1, 2009
(86) PCT No.: PCT/GB2009/050597

§ 371 Date: Mar. 24, 2011

(30) Foreign Application Priority Data
May 30, 2008 (GB) 0809875.8

(51) Int. Cl. H04W 4/00

(52) U.S. Cl. 455/432.1; 455/422.1

(57) ABSTRACT

A communications manager is disclosed that is provided on a telecommunications network and a terminal registered with that network. The communications manager comprises in the network and on the terminal a service manager; a data manager and a connection manager. The service manager and data manager collect and store data from a plurality of sources. The connection manager prioritises and schedules delivery of the data from the network to the terminal (or vice versa), and selects a communication method to provide the data in accordance with the priority of that data. The communication method may be SMS for high priority data or an activated packet data connection for lower priority data.

The present invention relates to a communications manager for managing communications between a telecommunications network core and a terminal registered with the network core, and to a method of managing communications between the telecommunications network core and a terminal registered with the network.

According to a first aspect of the present invention, there is provided a communications manager for managing communications between a telecommunications network core and a terminal registered with the network, the communications manager including means for collecting data from a plurality of sources; means for prioritising and scheduling delivery of the data to the terminal; and means for selecting a communication method to provide the data to the terminal in accordance with the priority of the data.

In the embodiment the collection of data from the various sources may be performed by a data manager. The prioritising and scheduling of delivery of data to the terminal, and the selecting of a communication method to provide the data to the terminal in accordance with the priority of the data may be performed by a connection manager.

The data may be generated by an event occurring in relation to an application with which the user of the terminal has made an association. In the embodiment a service manager includes “listeners” that detect such events and notify the data manager thereof.

The data may be prioritised according to its origin and/or type. For example, data originating from particular applications may be given a higher priority than data from other applications. Further, data of a particular type, such as contact data, may be given a higher priority than other data.

The selecting means may select one of a plurality of bearers to deliver the data to the terminal. The bearers may include, for example, SMS or an activated packet data connection. By “SMS” it is meant any suitable datagram or store-and-forward message delivery system (that may operate in a similar manner to SMS as defined in the GSM and UMTS Standards). The activated packet data connection may be established using a PDP context.

The prioritising and scheduling means may be operable to adjust the prioritising and scheduling of delivery of the data in dependence upon network communication conditions, such as the level of available network capacity. For example, if the network is very busy, the prioritising and scheduling may be adjusted for some data delivery to alleviate the congestion.

The prioritising and scheduling means may adjust the prioritising and scheduling of the delivery of data in dependence upon the type of subscription between the user of the terminal and the network, for example in dependence upon the tariff that the user has agreed with the network or on whether the user is roaming in the network and is registered with another network as their “home” network.

In the embodiment the network includes means for storing details of contacts used by the user of the terminal, which details of contacts are also stored on the user's terminal. The collected data may include updates to the contacts from third parties. The prioritising and scheduling means and the selecting means are operable in the embodiment to synchronise details of the contacts on the terminal with the details of the contacts on the network. Data relating to such synchronisation of contacts may be given a relatively high priority so that the synchronisation is maintained.

In the embodiment the terminal is a mobile terminal in radio communication with the network core via a suitable radio access network. The network may be a GSM, UMTS or SAE/LTE (4G) network.

The present invention also provides a communications manager for managing communications between a telecommunications network core and a terminal registered with the network core, the communications manager including means for collecting data from a plurality of sources; means for prioritising and scheduling delivery of the data from the terminal to the telecommunications network core; and means for selecting a communication method to provide the data to the telecommunications network core in accordance with the priority of the data.

A similar (symmetrical) but not identical communications manager may be provided in both the network core and terminal.

The present invention further provides a method for managing communications between a telecommunications network core and a terminal as defined in the claims.

For a better understanding of the present invention an embodiment will now be described by way of example, with reference to the accompanying drawings, in which:

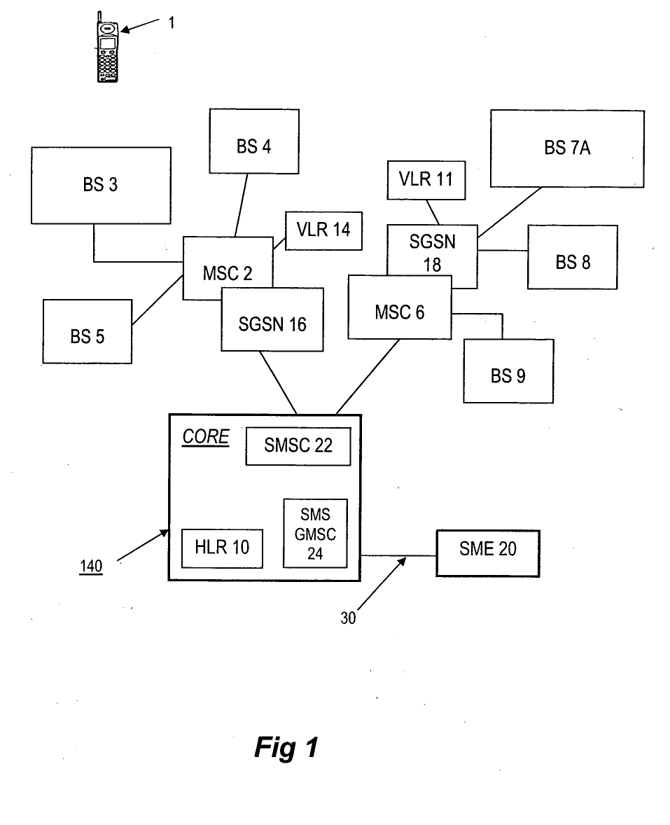

FIG. 1 is a diagrammatic drawing of key elements of a mobile telecommunications network;

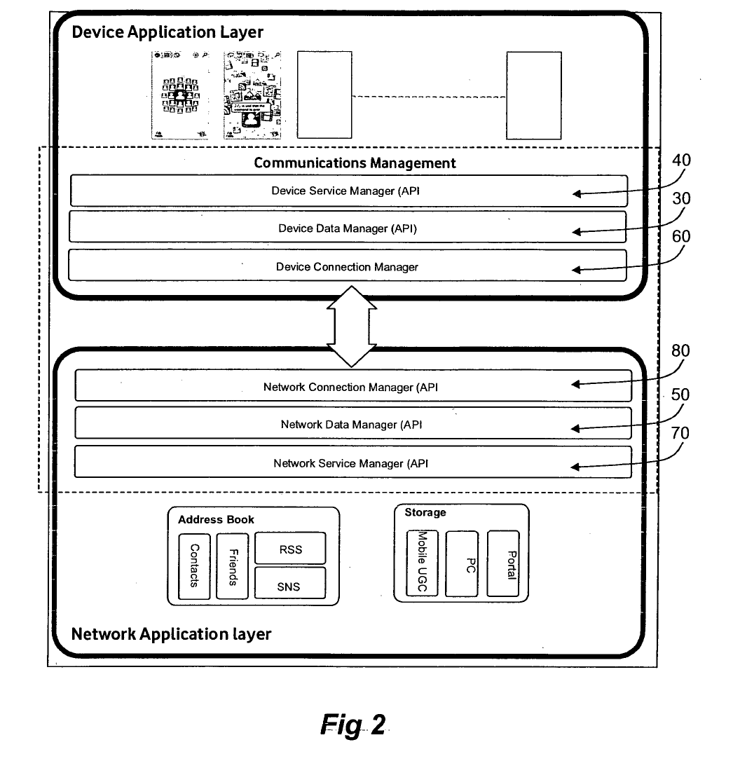

FIG. 2 shows the communications manager architecture on the network core and mobile terminal in accordance with an embodiment of the invention;

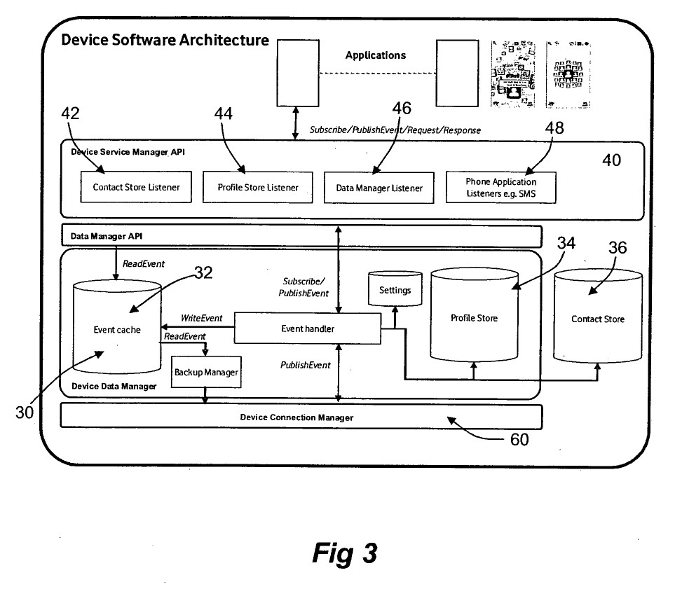

FIG. 3 shows, in more detail, the communications management architecture on the mobile terminal in accordance with the embodiment;

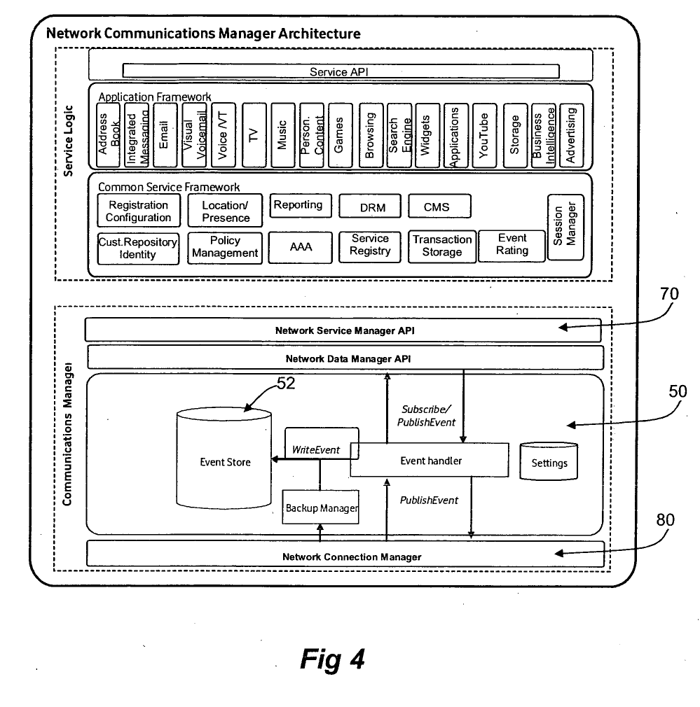

FIG. 4 shows, in more detail, the communications management architecture in the network core in accordance with the embodiments;

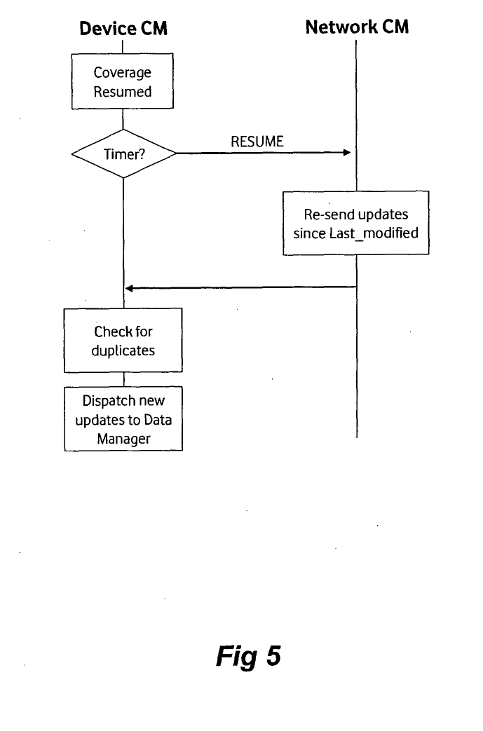

FIG. 5 shows the steps taken to perform a recovery from a coverage outage.

Key elements of a mobile telecommunications network, and its operation, will now briefly be described with reference to FIG. 1.

Each base station (BS) corresponds to a respective cell of its cellular or mobile telecommunications network and receives calls from and transmits calls to a mobile terminal in that cell by wireless radio communication in one or both of the circuit switched or packet switched domains. Such a subscriber's mobile terminal is shown at 1. The mobile terminal may be a handheld mobile telephone, a personal digital assistance (PDA) or a laptop computer equipped with a datacard.

In a GSM mobile telecommunications network, each base station comprises a base transceiver station (BTS) and a base station controller (BSC). A BSC may control more than one BTS. The BTSs and BSCs comprise the radio access network.

In a UMTS mobile telecommunications network, each base station comprises a node B and a radio network controller (RNC). An RNC may control more than one node B. The node B's and RNC's comprise the radio access network.

In the proposed LTE mobile telecommunications network, each base station comprises an eNode B. The base stations are arranged in groups, and each group of base stations is controlled by a Mobility Management Entity (MME) and a User Plane Entity (UPE).

Conventionally, the base stations are arranged in groups and each group of base stations is controlled by one mobile switching centre (MSC), such as MSC 2 for base stations 3, 4 and 5. As shown in FIG. 1, the network has another MSC 6, which is controlling a further three base stations 7A, 8 and 9. In practice, the network will incorporate many more MSCs and base stations than shown in FIG. 1. The base stations 3, 4, 5, 7A, 8 and 9 each have dedicated (not shared) connection to their MSC 2 or MSC 6—typically a cable connection. This prevents transmission speeds being reduced due to congestion caused by other traffic.

The MSCs 2 and 6 support communications in the circuit switched domain—typically voice calls. Corresponding SGSNs 16 and 18 are provided to support communications in the packet switched domain—such as GPRS data transmissions. The SGSNs 16 and 18 function in an analogous way to the MSCs 2 and 6. The SGSNs 16, 18 are equipped with an equivalent to the VLRs 11, 14 used in the packet switched domain.

Each subscriber to the network is provided with at least one smart card or subscriber identity module (SIM) card (strictly speaking a UICC) which, when associated with the user's mobile terminal, identifies the subscriber to the network. The terminal typically has an identifier of its own (the “International Mobile Equipment Identity”, IMEI), which can be obtained in certain networks, however this terminal ID is not essential in identifying the subscriber to the network. The SIM card is pre-programmed with a unique identification number, the “International Mobile Subscriber Identity” (IMSI) which can be accessed on the card but which is not generally known to (or used directly by) the subscriber. Printed on the outside of each SIM, there is often a further unique identification number, the ICCID/SIM Serial number (SSN), which is unrelated to the IMSI number. The subscriber is issued with a further, publicly known, number, that is, the subscriber's telephone number, by means of which calls to the subscriber are initiated by callers. This number is the Mobile Subscriber ISDN Number (MSISDN).

The network includes a home location register (HLR) 10 which, for each subscriber to the network, stores the IMSI and the corresponding MSISDN together with other subscriber data, such as the current or last known MSC or SGSN of the subscriber's mobile terminal.

When mobile terminal 1 is activated, it registers itself in the network by transmitting the IMSI (read from its associated SIM card) to the base station 3 associated with the particular cell in which the terminal 1 is located. In a traditional network, the base station 3 then transmits this IMSI to the MSC 2 with which the base station 3 is registered. In a network using the functionality described in 3GPP TS 23.236, the base station follows prescribed rules to select which MSC to use, and then transmits this IMSI to the selected MSC.

MSC 2 now accesses the appropriate storage location in the HLR 10 present in the core network 140 and extracts the corresponding subscriber MSISDN and other subscriber data from the appropriate storage location, and stores it temporarily in a storage location in a visitor location register (VLR) 14. In this way, therefore the particular subscriber is effectively registered with a particular MSC (MSC 2), and the subscriber's information is temporarily stored in the VLR (VLR 14) associated with that MSC.

Each of the MSCs of the network (MSC 2 and MSC 6) has a respective VLR (14 and 11) associated with it and operates in the same way as already described when a subscriber activates a mobile terminal in one of the cells corresponding to one of the base stations controlled by that MSC.

When the subscriber using mobile terminal 1 wishes to make a call, they enter the telephone number of the called party in the usual manner. This information is received by the base station 3 and passed on to MSC 2. MSC 2 routes the call towards the called party. By means of the information held in the VLR 14, MSC 2 can associate the call with a particular subscriber and thus record information for charging purposes.

The functionality just described may also apply to the proposed LTE mobile telecommunications network, with its eNode Bs performing the functionality of the base stations and the MME/UPE performing the functionality of the MSCs/VLRs. It is also to be appreciated that the functionality just described is one example of a network in which the embodiments of the invention may be implemented.

The procedure for transmission of “short messages” is different. The term “short messages” or “SMS messages” as used in relation to the embodiments means short messages as defined in the GSM or UMTS Standard Specifications, or a datagram delivered by a similar store-and-forward method. Such messages are commonly in the form of text messages of limited maximum length, but they can have other forms, such as in the form of binary data, or may contain configuration data for changing the functional parameters of a mobile.

Short messages may be sent to or from mobile terminals such as the mobile 1 and the others registered with the network. However, in addition, short messages may be sent to or from “short message entities” (SMEs) such as shown at 20. These SMEs may be in the form of terminals of various sorts such as fixed terminals for sending short messages of various types to mobiles and for receiving short messages from mobiles. For example, the SMEs may be in the form of terminals associated with banking computers or computers of other types generating information (control information, for example) for transmission to mobiles and for receiving short messages in response from mobiles, but may be of many other types, such as application servers of various types.

SMS is a service for transmitting simple short messages that contain text or other data between devices, that may or may not be in the same mobile network. The SMS facility is currently offered by almost all mobile devices (particularly those that use the GSM/UMTS system).

SMS communication is handled differently from calls due to SMS being non-interactive and not time critical. All SMS messages are handled by Short Message Service Centres (SMS-SC or SMSC). The network includes an SMSC 22 which routes the SMS messages of its subscribers to the network of the target device (the device to which the SMS should be sent). The SMSC 22 receives the SMS message along with the Mobile Subscriber ISDN Number (MSISDN) of the target device. In order to route the SMS message to the target device, the SMSC 22 must identify the target subscriber and to where the SMS should be routed. This data is obtained by the SMSC 22 signalling to an associated Short Message Service Gateway Mobile Switching Centre (SMS-GMSC) 24 which, in turn, signals to the target device's Home Location Register (HLR) 10 to determine to where the SMS message should be routed and the identity of the target subscriber. This process is known as a Routing Information Retrieval.

When receiving a Routing Information Retrieval, the HLR 10 responds with a Network Node Number to which the SMS message should be transmitted, which could be the address of the current serving MSC, SGSN or both, as well as the International Mobile Subscriber Identity (IMSI—see 3GPP TS 23.003).

As an optional enhancement, the home network of the target device may have deployed an SMS Router, not shown, (see 3GPP TS 23.840) which handles all incoming SMS messages for devices registered in a network. In this case, the Network node number passed to the SMS-GMSC 24 by the HLR is the address of the SMS Router. The SMS Router then takes on delivery of the SMS message to the current serving MSC or SGSN. Unlike the MSC or SGSN which changes as a mobile device moves around, the SMS Router is predominantly always the same. However, general O&M (operations and maintenance) and network upgrading mean the address can change, but this is infrequent, particularly compared to the change of current serving MSC/SGSN for a target device.

The SMS-GMSC 24 then forwards the SMS message, along with the received IMSI, on to the returned address from the HLR 10 (be that an MSC, SGSN or SMS Router), and in the successful case, the SMS message is delivered to the target device. The MSC and SGSN use the IMSI parameter to identify the target device.

Content (data) may be delivered to mobile 1 in the following way. A delivery server communicates with a content database and a scheduler and includes a Now SMS/MMS Gateway, which can be downloaded from www.nowsms.com. The Now SMS/MMS Gateway includes an SMS Gateway, a MMS Gateway, a WAP Push application and a Multimedia Messaging Service Centre (MMSC). The Now SMS/MMS Gateway has an internal MMS compiler, and requires for operation a GSM modem to be connected to the delivery server. The delivery server also communicates with the mobile device 1 via the GSM/3G network and BS 3.

If all required content is available, the scheduler program generates a URL at which the content can be found. The scheduler program then generates an HTTP GET request (a “delivery request”) for the Now SMS server. This triggers the Now SMS server to generate and send an MMS message. In the known manner, an SMS message is sent to the mobile device 1 to activate a PDP context and initiates the downloading of the content to the mobile device 1.

A communications management service in accordance with the embodiment can be characterised by:
A set of events that describe changes across a “connected” Address Book, Personalised Internet Feeds, Social Networks and within media applications e.g. ‘John is now listening to . . . .’
Storage of these events and related content across both PC and mobile.
Requests for information; either data objects within the Connection Manager system or user content.

It is these features that are designed to combine and deliver a compelling and differentiated user experience.

Owing to the diverse characteristics of various information sources, the service platforms that derive them and the performance demands required by the end user, careful consideration needs to be given to the management of data and its delivery, especially to mobile devices.

According to the embodiment of the invention, a Communications Management (CM) component is provided to address this need. The purpose of CM is to provide:
a consistent set of service APIs on the device and network for any authorised application,
a data management capability that minimises connection demands and ensures that data is available “on demand” through intelligent caching for any authorised application, and,
a connection management function that maximises the use of SMS datagrams, minimising the use of mobile radio packet data connections and subsequent UE impact.

The principle drivers for CM are derived from the Address Book, Personalised Internet and Social Network use cases (events) delivered to mobile—since they are the most “chatty”. The CM therefore comprises an engine upon which all other applications, such as Storage, can build on. Given the unknown behaviour of the system that drives these events (e.g. the number of social network service (SNS) events) it is also important that the CM engine and the algorithms that drive it are sufficiently parameterised to allow services to be tuned to optimise the user experience and resource usage (battery life and network).

The Communications Manager is provided in the network and the mobile device, and on each of these comprises three sub-components, as shown in FIG. 2. Each sub-component is defined by a set of functions exposed through an API.

A first sub-component is a device service manager 40 and a corresponding network service manager 70. A second sub-component is a device data manager 30 and a corresponding network data manager 50. The third sub-component is a device connection manager 60 and the corresponding network connection manager 80.

The Communications model comprises three types of message:
1. Event Messages: one-way messages from the device to network or network to device, typically invoked to notify subscribed applications of changes to data objects e.g. contacts and profiles.
   Events and their priorities are classified as follows:
   (a) Application Events. Application event subscriptions are implicit and are generated whenever a change is made to an associated data object on the network or device e.g. the Address Book applications on the device and network are notified of any changes made to User Profile or Contact data objects. Applications Events are HIGH PRIORITY.
   (b) User Subscribed Events. Internet (e.g. facebook, Flickr, YouTube etc.) and blog feeds require an explicit subscription to the relevant applications e.g. SNS aggregator service. Subscriptions to other user events are controlled by respective privacy settings maintained by each user. Each application thereby maintains a list of subscribed users who are notified via the Communications Manager when changes occur. User Subscribed Events are LOW PRIORITY and delivered on a best effort basis.
   (c) Comms Events. These are defined within the user experience (e.g. Last SMS, Last call, New Email etc.) and are aggregated across the device and network, by the Communications Manager, Comms. Comms Events are also LOW PRIORITY.
2. Request Messages; messages initiated by an application as a direct result of a user action or “system” procedure that invoke a response from the network (i.e. HTTP request-response). The network response typically contains a predetermined data structure.
3. Control Messages; messages are required to maintain the algorithms that define the communications and service model.

The Communications Manager is a message proxy that sits between mobile and network applications. The communications model is defined by a Service API within the device and network respectively. The Device side APIs are used to construct the mobile end-user applications and the Network side APIs are designed to serve both PC clients (e.g. browsers) and network applications serving mobile users.

Device service APIs can be classified as either Event message or Request message generating. The management of Event, Request and Control messages is the responsibility of the Communications Manager. Wherever possible the Communications Manager preferably uses a compressed SMS datagram to transmit events to the network.

Events are routed by the Communications Manager to subscribed applications and users on the device and on the network.

Requests to the Service API are prioritised, queued, compressed and transmitted to the network using connection-oriented, acknowledged, packet data connections (Mobile or WIFI). Requests APIs are qualified by response data.

Control Messages are generated and used by the Communications Manager to provide a robust service to help the system recover from system exceptions and perform maintenance e.g. coverage outage recovery, system time sync and subscriber checks.

Request, Events and Control messages are created when a service API is called. The API groups may include:
Address Book APIs, Blog APIs, Registration APIs, Event APIs, Policies APIs, Identity APIs, Calendar APIs, Control APIs, Settings APIs, Storage APIs.

The Registration process with the Communications Manager is outlined here for completeness and to provide context and origins for system parameters that are used by the Communications Manager.
When a user first powers-on an appropriately enabled device or first invokes a downloaded Communications Manager client, the registration process starts via a Registration Wizard application. The registration steps are as follows:
a. MSISDN is retrieved automatically from the network via USSD (*#100#) to provide a UserID.
b. The user is prompted to enter password—******.
c. These parameters are sent to the network together with the IMSI and mobile network code (MNC), identifying the subscriber's network. The MNC is used to verify whether the user is a subscriber of the network.
d. The network will in turn verify the user's MSISDN by sending a text message to the Registration Wizard for confirmation.
e. On receipt and acknowledgement of the confirmation message, the user account is created and a Registration Flag is set.
f. The Registration Wizard is then sent the Communications Manager OperatorList and valid Push Whitelist.
g. If the user is on their “home” network (IMSI checked with OperatorList) they will be prompted to select an appropriate special tariff plan for the Communications Manager. If they decline, service may be limited.
h. The user is then prompted to enter their internet identities (usernames and passwords) and personalised feed URLs e.g. www.flickr.com/feed/user. The SNS identities are subsequently used by the network to import internet contacts into the Address Book and create personalised feed entries in their profile.

This Registration Wizard is enabled through the Registration API and identity API.

At the end of the registration process, the Communications Manager and other applications will have access to several system critical parameters, specifically;
UserID and Password; used for HTTP connection authentication,
IMSI; to verify SIM (and tariff validity)
Registration Flag set; checked when the device is powered on.
Operator List; to detect roaming conditions.
Push Whitelist; used to authenticate network push messages.
Personal Internet Feeds; used to create fields in the user profile.

The Communications Manager software implementation is preferably layered, with each layer clearly delineated by an API.

Given the distribution scenarios for communications manager applications and the customer demographic network customers with a special tariff, network customers without a special tariff and non-home network/roaming customers), the default settings for automatic connections need to be configurable.

The Communications Manager settings may include options for “request user confirmation for network connections” and allow connections to be made automatically.

Customers provisioned on the special tariff, set “automatic retrieval” as the default on installation.

For all customers who are not signed up to the special tariff, the default shall be set to “request user authorisation”.

Users who are not on the special tariff and who wish to allow automatic connections will be able to change this default setting.

Noise Control allows the user to set which network originated events they want to receive, specifically.
Friend profile and blog updates.
Subscribed (friend's) internet feed updates e.g. www.flickr.com/feed/userID
Social networking events e.g. facebook updates

These groups of events define filter parameters for the Noise Control API. The user settings for Noise Control are stored on the device and network and synchronised whenever a change is made.

The user can set permissions for different types of data on the device, specifically; contacts, MyProfile, MyBlog, MySharedFolder, MyCalendar. Permissions settings are stored on the device and network and synchronised whenever a change is made.

When the user powers on the device, the Communications Manager needs to run several system checks to verify system critical parameters.

When the device is powered on for the first time it needs to establish if the user is registered for service. The Registration Flag is checked. If false, the registration process is initiated and the Registration Wizard launched.

When the device battery has been removed, time settings may be reset. It is important that the device time is kept in sync with the network time when generating event time stamps. The Communications Manager refreshes the device time via a network request. A time check is carried out each time the device connects to the network. The device time does not affect device time zone settings and is maintained separately.

If a user inserts a new SIM card into their device e.g. a new SIM of the same network operator or another operator SIM, the tariff structure used to support unlimited events may not apply. The subscriber's network can be identified from the MNC.
At start-up the CM shall verify the user's “registered” SIM (IMSI & MNC).
If the MNC is different to that at the time of registration the user shall be asked to reconfirm connection settings, that is “request user confirmation before connecting to the network” or “allow the AB to connect automatically”.
The network shall be informed of any IMSI (SIM) change. The network may then take appropriate action e.g. allow automatic Address Book updates only, disable all other feeds.

Device Communications Management Architecture

The Device Communications Management Architecture is shown in FIG. 3.

Device Service Manager

The Device Service Manager 40 supports a set service APIs that create either Application Requests, Events or Control messages.

In order to create an event in response to a service API call the Device Service Manager 40 comprises “listener applications” that run in the background and listen for events on behalf of other applications. In turn, the listener applications subscribe to Network Application events published by network applications, via the Data Manager 50, and also Phone Application Events e.g. received SMS.

The Service Manager 40 supports Listeners for the following;
Listener 42 for Contacts Store 36, detecting modifications by the Device and Network Address Books
Listener 44 for Profiles Store 34, detecting modifications to My Profile and Friend profiles.
Listener 46 for Event Cache 32, network originated modifications
Listener 48 for Phone applications; SMS, Call Log, MMS, IM and Visual Voicemail
Settings updates.

The Listeners, on receiving an event, notify subscribed applications, e.g. Homescreen, and write device-originated events to the Data Manager 30. The Data Manager 30 may also subscribe to the Service Manager listeners.

The following applications by default are permitted to use the Service APIs, subscribe and publish system events.
Registration Wizard
Address Book
Calendar
Homescreen
Device LifeDrive (a timeline of events defined in the Noise Filter).
IM Client.
Integrated Messaging Client (TBD)
Visual voicemail client
Others TBD

The Service Manager 40 combines several data objects to define the Address Book data objects.

An Address Book data object comprises both Profile and Contact data (for registered users). Contact data only (for unregistered users) and LastXevents associated with a contact in the events cache.

Device Data Manager

The Device Data Manager 30, FIG. 3, is responsible for;
Handling device-originated events and updating either the Device Event Cache 32 or Network Address Book when either the User Profile or Contact Stores 34,36 are modified.
Handling network-originated events and updating the Device Event Cache 32, Friend Profile in the Profile Store 34 and Contacts in the Contact Store 36.
Backing-up all device originated Comms Events to the Network Store.
Managing device and service settings

The Event Cache 32 is not infinite and only contains the most recent event updates. To compensate for this finite storage capability the cache is supported by a Network Event Store 52 (Managed by the Network Data Manager 50). The Device Data Manager 30 therefore needs to manage the periodic back-up of data to the Network Event Store 52 and retrieval of events not stored in the device cache (e.g. old events).

When the Event Cache 32 is full, the oldest events are discarded (from the bottom of the stack) and new Events are added (to the top of the stack).

When an application receives a request for an event that is not stored in the Event Cache 32 (e.g. an old event), the device returns the URL of the Network Event Store 52.

At EventCacheBackupTime intervals the Data Manager 30 backs up all device originated events to the Network Event Store 52.

When a user, with an established Network Event Store 52, migrates to a new handset the device Event Cache 32 comprises no events.

If a device is lost, the network may send a DeviceWipe message and erase all end user data; Event Cache 32 Profile Store 34 Contacts Stored Messages and User Content.

The data manager 30 stores:
Registration flag
Username and password for autnentication purposes.
User IMSI
Operator List
Network time
Push Whitelist
Noise control settings
Account permissions
Connection Manager parameters
Application certificates
Software version

Device Connection Manager

The Device Connection Manager (DCoM) 60 provides reliable, optimised communication for the Data Manager 30 and end user applications. It is configurable and is also responsible for registration/authentication/update and storing control parameters received from the network.

The DCoM 60 also supports unfavourable communications states and informs the network when delivery should be suspended. This capability is important in maintaining Address Book synchronisation and allows any network originated changes to be stored and delivered at a later time. The specific conditions supported are:
Lower Power
Power Off
Roaming
Out of Coverage

All events are queued according to priority. All Address Book related events have the highest priority and shall be actioned immediately.

Given the data size of some events (e.g. Address Book contact field update), packet data connections are considered inefficient and may have a negative effect on the end user experience.

Where appropriate, the DCoM 60 shall use SMS to transfer data to and from the network. If the event payload size exceeds that maximum SMS payload a packet data connection shall be initiated (for example, by sending an SMS message to the mobile device 1 to activate a PDP context and to initiate the downloading of the data to the mobile device 1 in the manner described above). If there is no available PDP context and a packet connection is required the Connection Manager shall give priority to all Address Book events and close connections not in use by other applications to fulfil any device or network initiated update. All other updates shall wait until a free PDP context becomes available.

During Lower Power states the network may be required to suspend event delivery. When the device power level is critical, the DCoM 60 sends a SUSPEND message to the network. Conversely, when the device power recovers or is put on charge, the DCoM 60 sends a RESUME message to the network.

When the device is Powered Off the network will be required to suspend event delivery. Prior to the device being powered off the, the DCoM 60 shall send a SUSPEND message to the network. Conversely, when the device powers on, the DCoM 60 shall send a RESUME message to the network.

Because the device may be roaming, owing to the automatic retrieval and transmission of network and device originated events, the Connection Manager needs to support control triggers to allow the network to suspend delivery, or request user authorisation before a connection is made. The Connection Manager maintains a list of all networks within the special Tariff plan—[Operator List]. The device notifies the network when the registered device PLMN is not on the [Operator List]. The device exposes a tariff flag to device applications to inform users of the current registration state (and in turn tariff change). On receiving the PLMN message, the network may suspend event delivery.

When the device is out of coverage (see FIG. 5) for a defined time the network is not aware that device has not received notifications. In the interim, the user may modify the Address Book via the web and phone Contact and Profile Stores may lose synchronisation.
When the device out of coverage for >[Coverage Time] and device coverage is recovered, the device sends a RESUME delivery message to the network.
On receiving the RESUME message the network delivers all queued events.

Advantageously, the Connection Manager removes duplicate events before passing to the Data Manager 30.

Preferably, on each data connection, the network checks the current software version and initiates a software update if a new version is available.

Network Communications Manager Architecture

The Network Communications Manager architecture is shown in FIG. 4. The

Network Communications Manager is a high capacity, scalable, resilient, concurrent message handling system capable of serving millions of mobile clients. The Network Communications Manager must be able to handle concurrent messaging with registered mobile devices.

Network Service Manager

A key difference between the network side architecture and the device-side architecture is that the network-side applications are modular and functions are not shared across the device software platform e.g. the contact store in the Address Book resides entirely within the application.

The Network Service Manager 70 subscribes to events from the Network Data manager 50 on behalf of authorised network based applications.

On receiving an event from the Network Data Manager 50, the Service Manager 70 filters the event and writes data using the relevant application service APIs.

Network Data Manager

The Network Data Manager 50 receives events from the Network Connection Manager 80 and Network Service Manager 70 and routes them to subscribed applications and users respectively. Events received from the Network Service Manager 70 are filtered according to the user Noise Control settings. The Data Manager 50 writes all network originated events to the network event store 52. The Data Manager 50 backs-up mobile originated Comms Events at EventCacheBackupTime intervals.

Network Connection Manager

The Network Connection Manager (NCoM) 80 provides reliable, optimised communication for the Data Manager 50 and end user applications. It maintains the configuration of device-side software and is responsible for registration/authentication/update.

The NCoM 80 receives published events from the Data Manager 50 and schedules their delivery.

All events received from the Data Manager 50 are stored in the relevant (High and Low) priority queues to await delivery.

All Network Service Manager 70 originated events shall be stored in the Network Event Store 52.

For a given user, the NCoM 80 selects either SMS or Packet delivery based on the amount of data stored in the queue. The algorithm is identical to that used by the Device.

All events (Address Book updates, SNS updates etc.) have a validity time. If, for any reason, the event validity time (e.g. 3 days) expires, the Device Address Book (profile and content stores) are refreshed when the device resumes service. The Network Connection manager 80 shall initiate the refresh on receiving a RESUME command from a registered device.

Non-Address Book events are discarded when the message validity time expires. The NCoM 80 removes duplicate events before passing to the Data Manager 50.

SMS updates use delivery reports to confirm receipt from the destination SMSC 22. If the deliver report is not received within DeliveryReportTimeout, the update shall be re-sent.

The NCoM 80 authenticates packet data connections using HTTP authentication methods. Device-originating SMS datagram authentication is implicit and uses the originating MSISDN. Network originated SMS datagrams shall be authenticated using the PushWhiteList.

Connection Manager Parameter Summary:

| Parameter | Description |
|---|---|
| CoverageTimer | Message trigger for delivery RESUME. |
| DeliveryReportTimeout | Re-transmission timer for network and mobile |
| | originated updates in the event of no SMS |
| | delivery report |
| OperatorList | List of PLMNs within the special tariff. |
| EventMessageExpiry | Time to live for all events. |
| EventCacheBackupTime | Interval between device event cache backups. |
| | Must be set to maintain cache underflow |
| PushWhiteList | Authorised network address. |

An example will now be described where the network stores an address book for the user of the mobile terminal. The address book is enhanced with rich contact information. For example, the address book may gather information about a particular contact from social community websites such as facebook and MySpace. The contact information in the user's address book may be shared with other users, so that when an entry is updated, the updated data is automatically propagated to the other user. The address book data needs to be synchronised with the mobile device of each relevant user.

Conventionally, such an arrangement would cause difficulties because changes made to the address book will occur sporadically. Conventionally, to update the address book on the relevant user terminals, a message is sent from the network to the terminal to prompt the user to open an active packet data connection. It is an unsatisfactory user experience to be repeatedly prompted at random times to open an active packet data connection in order to synchronise an address book.

In accordance with the embodiment of the invention, the network service manager 70 receives updates to the address book from various sources, such as from other users and from social community websites such as facebook and MySpace. The network data manager 50 writes the data into the network event store 52. The network data manager 50 then publishes the data to the network connection manager 80. The NCoM 80 prioritises the data by type. Updates to the address book will generally be given a relatively high priority. The data is then queued according to its priority and is transmitted by a suitable method (SMS or packet delivery) in dependence upon its priority and the amount of data in the queue.

Higher priority data can be sent by SMS almost in real time as it is received by the network service manager 70. Lower priority data can be sent periodically by establishing a packet data connection (for example once every 24 hours).

Advantageously, the network communication manager 80 is aware of the functionality provided by a user's handset and can modify how the data are transmitted to the mobile terminal and the format of the data in dependence upon the handset functionality.

The embodiment is also applicable to the delivery of instant messages (IM) to the terminal.

Device Service API Package Definitions

To assist the reader in understanding the embodiment described above, there follows a listing of the definitions for the API packages used by the device—in particular those commonly used in support of devices service APIs for Registration, Identity, Contact, Policy, Blog, Calendar, User Subscribed Events and Storage.

Private device side APIs can only be used by certified applications. All Connection Manager Service APIs on the device are Private APIs.

Some Connection Manager service APIs will map directly to public APIs on the phone software platform APIs. This implies that other applications on the device may modify the Address Book contact data.

Contact (vCard), Profile (vCard extensions) and Event data combine within the Address Book application to create a differentiated user experience.

At the device service API Layer no authentication parameters are passed. The Connection Manager will use the relevant (SMS datagram or packet session) authentication data objects when sending data to the network.

Registration API

NewUserID (Private)

Creates a new user ID.

| Parameters | Description |
|---|---|
| UserID | MSISDN |

SetPassword (Private)

Sets the users password.

| Parameters | Description |
|---|---|
| UserID | MSISDN |
| Password | New user password |

MobileValidateMSISDN (Private)

Originated by the network to Registration Wizard application to verify MSISDN at registration. Note, the MobileValidateMSISDN contains an Application ID (not required for web validation).

| Parameters | Description |
|---|---|
| UserID | MSISDN |
| ApplicationID | Registration Wizard |
| Validation key | Alphanumeric key |

AcknowledgeMSISDN (Private)

The Registration Wizard confirms receipt of the MSISDN through a validation message.

| Parameters | Description |
|---|---|
| ApplicationID | Address of ValidateMSISDN orginator |
| Validation key | Alphanumeric key |

Identity

The supported Social Networking and Personalised Internet feeds are defined in the Identity Data Object.

SetIdentities (Private)

Sets an Identity data object field.

| Parameters | Description |
|---|---|
| UserID | User MSISDN |
| Identity Data Object Field | Value |

Adddentity (Private)

Adds a new internet community for a user.

| Parameters | Description |
|---|---|
| UserID | User MSISDN |
| IdentityName | Name of community to be added. |

DeleteIdentity (Private)

Deletes a network identity.

| Parameters | Description |
|---|---|
| UserID | User MSISDN |
| IdentityName | Name of community to be deleted. |

Contacts

CreateUserProfile (Private)

Defines a new user profile after registration.

| Parameters | Description |
|---|---|
| Contact ID | MSISDN of registered user |

AddProfileDetail (Private)*

Adds new profile detail.

| Parameters | Description |
|---|---|
| Contact ID | MSISDN of invited contact |
| Profile field | Profile object field |

SetProfileDetail (Private)

Sets existing profile detail.

| Parameters | Description |
|---|---|
| Contact ID | MSISDN of invited contact |
| Profile field | Profile field to be changed |
| Profile field data | Profile object field data |

AddContact (Private)

Adds new contact.

| Parameters | Description |
|---|---|
| Contact Object List | Default list of ContactObject data |

AddContactDetail (Private)

Adds new contact detail.

| Parameters | Description |
|---|---|
| Contact ID | MSISDN of contact to be changed |
| Contact Object List | New ContactObject data field |

AddContactDetailBytes (Private)

This method adds one detail in binary format (e.g. photo) to an already existing contact.

| Parameters | Description |
|---|---|
| Contact ID | MSISDN of contact to be changed |
| Contact Object Field | New ContactObject data field |
| Contact Object Data | Binary object |

AddContactDetails (Private)

Adds more than one contact detail.

| Parameters | Description |
|---|---|
| Contact ID | MSISDN of contact to be changed |
| Contact Object List | New ContactObject data fields |

DeleteContactDetails (Private)

Deletes more than one contact detail.

| Parameters | Description |
|---|---|
| Contact ID | MSISDN of contact to be deleted |
| Contact Object List | ContactObject data fields to be deleted |

DeleteContacts (Private)

Deletes one or more contacts and their profiles.

| Parameters | Description |
|---|---|
| Contact IDs | MSISDN of contacts to be deleted |

GetContactDetails (Private)

Gets contact detail.

| Parameters | Description |
|---|---|
| Contact ID | MSISDN of contact to be changed |
| Response | Contact and Profile details |

InviteUserAsFriend (Private)

Invites a contact to be a Friend (Note, if the invitation is sent to an unregistered contact, the contact will need to register first before accenting the invitation)

| Parameters | Description |
|---|---|
| InvitationText | Personalised invitation text |
| Contact ID | MSISDN of invited contact |

RejectInvitation (Private)

Rejects a friend invitation.

| Parameters | Description |
|---|---|
| Contact ID | MSISDN of inviter contact |

GetContacts (Private)

Returns a user contacts.

| Parameters | Description |
|---|---|
| Contact ID List | Contact details of listed contacts |
| Response | Contacts list |

GetFriendsOfFriends

Gets the contacts list of a friend, subject to permission.

| Parameters | Description |
|---|---|
| Contact ID | MSISDN of contact |
| Response | Contacts list |

GetUserProfiles

As for GetContacts. Returns all Friend profiles.

LinkContacts

Where internet contacts are imported following SNS identity (e.g. Facebook entry), the user may be provided with hints that two contacts are in fact the same. This API is not applicable to the device UE and is confined to the PC interface.

SetContactDetail (Public)

Sets and existing contact detail.

| Parameters | Description |
|---|---|
| Contact ID | MSISDN of contact |
| Contact field | Contacts field to be set |
| Contact field value | New contact field value |

SetContactDetails (Public)

As above but for more than one detail.

SetContactDetailBytes (Public)

Sets binary contact detail e.g. photo

| Parameters | Description |
|---|---|
| Contact ID | MSISDN of contact |
| Contact field | Contacts field to be set |
| Binary contact field value | Binary object (photo) |

GetContactsByLocation (Private)

This function is used to retrieve a list of contacts from the contacts list which are located in a given radius around the current location of the Connection Manager system user which is performing the request.

| Parameters | Description |
|---|---|
| Contact Radius | Radius filter in km |
| Response | Map data object with contacts located (subject |
| | to permissions) |

AddGroup (Public)

Adds a new contact Group

| Parameters | Description |
|---|---|
| Group Name | New group name |

DeleteGroup*(Public)

Deletes a contact group.

| Parameters | Description |
|---|---|
| Group Name | Group name to be deleted |

AddUserToGroup*(Public)

Adds a contact to a group.

| Parameters | Description |
|---|---|
| Group Name | Target group name |
| Contact ID | MSISDN of contact to be added to group |

PokeUser

Sends a Poke event to a Friend.

| Parameters | Description |
|---|---|
| Contact ID | MSISDN of contact to be added to group |

DeleteUserFromGroup*(Public)

Deletes a contact from a group.

| Parameters | Description |
|---|---|
| Group Name | Target group name |
| Contact ID | MSISDN of contact to be deleted from group |

Policies

GetTermsAndConditions (Private)

Gets services terms and conditions

| Parameters | Description |
|---|---|
| UserID | MSISDN |
| Language | T&C language |
| Response | Terms and conditions text |

SetAccessPermissions (Private)

Sets access permissions for defined filter objects.

| Parameters | Description |
|---|---|
| UserID | User MSISDN |
| Permissions List | Filter defining the permissions to be set |
| Permission value | No-one, friends, Groups, all except blacklist, |
| | everyone |

Filters:
ContactPermissions: Contact data objects
ProfilePermissions: Profile data objects
BlogPermissions: Blog data objects
StorageFolderPermissions: Storage data objects
CalendarPermissions: Calendar data objects

GetAccessPermissions (Private)

Retrieves user access permissions list for data objects stored in the Connection Manager system. As a minimum, a user must provide access to their Contact Name.

| Parameters | Description |
|---|---|
| UserID | User MSISDN |
| Permissions List | Filter defining the permissions to be retrieved |
| Response | A list of retrieved permission objects |

SetNoiseControlSettings (Private)

Defines event notification settings for different event filters.

Event Filters:
Profiles: events associated with changes to friend profiles
CommunityUpdates: events associated with set within the registered Identities
SubscribedFeedUpdates: events associated with user subscribed feeds, either personal internet feeds (e.g. Flickr) or Connection Manager friend blog feeds.
CalendarEvents

| Parameters | Description |
|---|---|
| UserID | User MSISDN |
| Originator Filter | (All, Groups, ContactID) |
| Noise Filter List | Event filter list |
| Noise Filter Value | Event filter values = true/false |

GetNoiseControlSettings (Private)

Retrieves the current NoiseControlSettings.

| Parameters | Description |
|---|---|
| UserID | User MSISDN |
| Response | Event filter list and values |

Check4BlackListed (Private)

Returns list of black listed contacts.

| Parameters | Description |
|---|---|
| UserID | User MSISDN |
| Response | List of black listed contacts |

SetBlackList (Private)

Sets contact black list.

| Parameters | Description |
|---|---|
| UserID | User MSISDN |
| Contact BlackList | Contact/value pairs on BlackList |

Blogs

GetEntries (Private)

Add Entry (Private)

DeleteEntry (Private)

CommentEntry (Private)

Calendar

AddCalendarEvent (Private)

DeleteCalendarEvent (Private)

SetCalendarEventDetail (Private)

AcceptCalendarEventlnvitation (Private)

RejectCalendarEventlnvitation (Public)

GetCalendarEvent (Public)

User Subscribed Events

SubscribeToEvent* (Private)

Allows the user to subscribe to events on the internet and within Connection Manager.

| Parameters | Description |
|---|---|
| Contact | MSISDN |
| EventSubscription | Contact blog or registered feed URL defined in |
| | profile |
| Response | UserSubscriptionList object containing a list of |
| | subscriptions with a unique ID |

DeleteSubscription* (Private)

Deletes a user subscription.

| Parameters | Description |
|---|---|
| UserSubscriptionListEntry | User subscription list entry to be deleted |

ShareEvent (Private)

Not required. Shared Events e.g. Music Player ‘Now listening to . . . .’ can be supported through Blog.AddEntry.

Storage

AddFolder (Private)

RemoveFolder (Private)

GetFolders (Private)

SetFiles (Private)

DeleteFiles (Private)

SetFolderPermissions* (Private)

Data Model Definitions

All Connection Manager data objects are stored in the network. Where data objects are replicated or cached on the device any change must be synchronised with the network. The data objects take the forms set out below:

Contact Data Object (Synchronisable)

| vCard 2.1 Fields Type | Value |
|---|---|
| Name | [vCard] |
| Thumbnail | [vCard] |
| Postal Address | [vCard] |
| Mobile Number | [vCard] |
| Home Number | [vCard] |
| Business Number | [vCard] |
| Personal email | [vCard] |
| Business email | [vCard] |

Profile Data Object (Synchronisable)

| Fields | Value |
|---|---|
| Birthday | [vCard] |
| Timezone | [vCard] |
| Geographic Position | [vCard] |
| Status text | Status text for user |
| Mood smilie | Smilie object |
| MyBlog | www.vodafone.com/blog/msisdn |
| Identity | Identity name |

Identity Data Object (Synchronisable)

The Identity Data Objects comprise a registered identity list stored on the network and cached on the device.

| Fields | Value |
|---|---|
| Name | Community name |
| Username | Username for community |
| Password | Password for community |
| Feed URL | URL of community feed |

Contact BlackList Data Object (Synchronisable)

The Contact Black List is stored on the network and cached on the device.

| Fields | Value |
|---|---|
| Contact MSISDN | True/false |

User Subscription List Data Object (Synchronisable)

The User Subscription List is stored on the network and cached on the device.

| Fields | Value |
|---|---|
| Contact ID | MSISDN of subscribed contact feed |
| Feed URL | URL of contact feed |

Calendar Event Object (Synchronisable)

Calendar Event Objects (entries) are stored on the network and device. As defined by [vCal]

| Field | Value |
|---|---|
| ContactEvent | Change in the Contact Data object |
| CommsEvent | Change to the comms event data object |
| ProfileEvent | Profile Object field change |
| BlogEvent | Blog feed change |
| CommunityEvent | Registered community notification |
| FriendFeedEvent | Change to friend internet feed |

Event Data Object (Synchronisable)

Event Data Objects are stored on the network and cached on the device.

| Field | Value |
|---|---|
| Placed Calls | MSISDN, Time, Date |
| Received Calls | MSISDN, Time, Date |
| Missed Calls | MSISDN, Time, Date |
| Sent SMS | MSISDN, Time, Date |
| Received SMS | MSISDN, Time, Date |
| Sent MMS | MSISDN, Time, Date |
| Received MMS | MSISDN, Time, Date |
| New Email | [OMA email notification] |
| Visual VoiceMail | MSISDN, Time, Date, Phone Location |
| Sent IM | MSISDN, Time, Date |
| Received IM | MSISDN, Time, Date |

Comms Event Data Object (Synchronisable)

Blog Data Object

TBD

Permissions Settings Data Object (Synchronisable)

Noise Filter Settings Data Object (Synchronisable)

Filter Definitions

As mentioned previously, the embodiment allows the user to set which network originated events they want to receive. The filters take the forms set out below:

Permissions Filters

| Permission Lists | Value |
|---|---|
| ContactList | Contact names |
| ProfileList | Profile object |
| Blog | Blog URL |
| StorageFolders | |
| Calendar | Calendar entries |

Noise Control Filters

| Permission Lists | Filter Description |
|---|---|
| ProfileUpdates | All friend profile change events |
| CommunityUpdates | All registered community events |
| SubscribedFeedUpdates | List of user subscribed feeds (other |
| | user blog feeds and personalised |
| | internet feeds) |
| StorageFolderUpdates | SetFiles events |
| CalendarEntries | Calendar entries, subject to |
| | permissions |

1. A communications manager for managing communications between a telecommunications network core and a terminal registered with the network core, the communications manager including:
a collecting component that collects data from a plurality of sources, wherein the data are generated by at least one of: a change event, a request message or a control message occurring in relation to an application with which a user of the terminal has made an association;
a delivery component that prioritizes and schedules delivery of the data to the terminal; and
a selecting component that selects a communication method to provide the data to the terminal in accordance with the priority of the data.

2. (canceled)

3. The communications manager of claim 1, wherein the data are prioritised according to at least one of: an origin of the data or a type of the data.

4. The communications manager of claim 1, wherein the selecting component selects one of a plurality of bearers to deliver the data to the terminal.

5. The communications manager of claim 4, wherein the bearers include at least one of: SMS or an activated packet data connection.

6. The communications manager of claim 1, wherein the delivery component is operable to adjust the prioritising and scheduling of delivery of the data in dependence upon the network communication conditions.

7. The communications manager of claim 6, wherein the network communication conditions include the level of available network capacity.

8. The communications manager of claim 1, wherein the delivery component is operable to adjust the prioritising and scheduling of delivery of the data in dependence upon the type of subscription between the user of the terminal and the network.

9. The communications manager of claim 8, wherein the type of subscription includes at least one of: a type of tariff of the user of the terminal or whether the user of the terminal is roaming in the network.

10. The communications manager of claim 1,
a storing component that stores details of contacts used by the user of the terminal, which details of contacts are also stored on the terminal, wherein the data includes updates to the contacts from third parties, and wherein the delivery component and the selecting component are operable to synchronise the details of the contacts on the terminal with the details of the contacts on the network.

11. The communications manager of claim 1, wherein the terminal is a mobile terminal that communicates with the network core via a radio access network.

12. The communications manager of claim 1, wherein the network core is the network core of at least one of: a GSM, a UMTS or a SAE/LTE network.

13. A method of managing communications between a telecommunications network core and a terminal registered with the network, the method comprising:
collecting data from a plurality of sources, wherein the data are generated by at least one of: a change event, a request message or a control message occurring in relation to an application with which a user of the terminal has made an association;
prioritising and scheduling delivery of the data to the terminal; and
selecting a communication method to provide the data to the terminal in accordance with the priority of the data.

14. A communications manager for managing communications between a telecommunications network core and a terminal registered with the network core, the communications manager comprising:
a collection component that collects data from a plurality of sources, wherein the data are generated by at least one of: a change event, a request message or a control message occurring in relation to an application with which a user of the terminal has made an association;
a delivery component that prioritizes and schedules delivery of the data from the terminal to the telecommunications network core; and
a selecting component that selects a communication method to provide the data to the telecommunications network core in accordance with the priority of the data.

15-16. (canceled)
